(19) United States
(12) Patent Application Publication
(10) Pub. No.: US 2009/0265611 A1
(43) Pub. Date: Oct. 22, 2009

(54) WEB PAGE LAYOUT OPTIMIZATION USING SECTION IMPORTANCE

(75) Inventors: Srinivasan H. Sengamedu, Bangalore (IN); Rupesh R. Mehta, Solapur (IN)

Correspondence Address: Weaver Austin Villeneuve & Sampson - Yahoo!, P.O. BOX 70250, OAKLAND, CA, 94612-0250, US

(73) Assignee: Yahoo ! Inc., Sunnyvale, CA (US)

(21) Appl. No.: 12/116,825

(22) Filed: May 7, 2008

(30) Foreign Application Priority Data
Apr. 18, 2008 (IN) 971/CHE/2008

(51) Int. Cl. G06F 17/00; G06F 17/20; G06F 17/21

(52) U.S. Cl. 715/234; 715/238

(57) ABSTRACT

Methods and apparatus are described which enable the efficient adaptation of web pages to mobile displays. The more important or relevant sections of a web page are identified and configured into a more compact form. Both layout preserving and high compaction techniques are described.

### BACKGROUND OF THE INVENTION

The present invention relates to determining layouts for rectangular web page sections and, in particular, to optimizing such layouts for the smaller displays of mobile devices.

Recently there has been a proliferation of Internet-enabled mobile devices. Unfortunately, because the vast majority of web pages were designed for presentation on relatively large displays (e.g., desktop and laptop PCs) via relatively high bandwidth connections, the presentation of web pages on the relatively small screens of mobile devices with their associated bandwidth constraints poses a number of problems.

### SUMMARY OF THE INVENTION

According to the present invention, techniques are provided for optimization of web page layouts using section importance. According to a particular class of embodiments, methods and apparatus are provided for configuring a web page characterized by an original layout for presentation on a display having a display area. Web page section data are received as input. The web page section data represent rectangular sections of the web page. Each rectangular section was derived from the original layout and scaled with reference to a relevance measure for the corresponding rectangular section. The web page section data are manipulated with reference to the display area to arrange the rectangular sections in a new layout smaller than the original layout.

According to another class of embodiments, methods and apparatus are provided for facilitating presentation of a web page characterized by an original layout on a display having a display area. A representation of the web page is caused to be transmitted to a device including the display. The representation of the web page is characterized by a new layout smaller than the original layout. The new layout represents an arrangement of rectangular sections of the web page. Each rectangular section was derived from the original layout and scaled with reference to a relevance measure for the corresponding rectangular section. The arrangement of the rectangular sections was derived with reference to the display area.

A further understanding of the nature and advantages of the present invention may be realized by reference to the remaining portions of the specification and the drawings.

### BRIEF DESCRIPTION OF THE DRAWINGS

FIG. 1 is a flow diagram illustrating operation of a specific embodiment of the invention.

FIG. 2 is a flowchart illustrating operation of a web page sectioning technique for use with embodiments of the invention.

FIG. 3 is a flowchart illustrating operation of a technique for laying out rectangles according to a specific embodiment of the invention.

FIG. 4 is a simplified representation of rectangles illustrating aspects of a particular embodiment of the invention.

FIG. 5 is a flowchart illustrating operation of another technique for laying out rectangles according to a specific embodiment of the invention.

FIG. 6 is an example of a web page with sections marked as important highlighted.

FIG. 7 is an example of a new layout of the sections of the web page of FIG. 6 according to a particular embodiment of the invention.

FIG. 8 illustrates a revision of the layout of FIG. 7.

FIG. 9 is another example of a new layout of the sections of the web page of FIG. 6 according to another particular embodiment of the invention.

FIG. 10 illustrates an example of the insertion of content in a blank space of the layout of FIG. 9.

FIG. 11 is a simplified diagram of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Specific embodiments of the invention provide techniques for modifying the layout of web pages for presentation on the smaller displays of mobile devices. Web pages designed for larger displays typically include information which, from the user's perspective, is less relevant than the primary information the user is attempting to access. Such information might include, for example, the page header, navigation bar, advertisements, etc. Embodiments of the invention are operable to compress or eliminate less relevant information, and to configure the layout of the remaining information in a manner which results in a more suitable presentation of the modified web page than conventional techniques.

According to a particular class of embodiments, this is done in two phases. In a first phase, a decision is made as to which portions of a web page are “informative,” i.e., likely relevant to the user, and which are not. According to specific embodiments, this is done by dividing the web page into sections and assigning a relevance score to each section. Typically, sections including less relevant information or “noise” will have a low relevance score. Then, in a second phase, the web page sections are configured for presentation on the target display using the associated scores and the size of the target display.

Specific embodiments of the invention are described below with reference to examples of specific techniques for conducting the first phase described above. It should be noted, however, that there are a variety of ways in which this phase may be accomplished without departing from the scope of the invention. For example, there are a variety of information extraction techniques for sectioning web pages and scoring web page sections in the context of indexing web pages for search. Such techniques may be adapted for use with the present invention. Therefore, the present invention should not be limited with reference to specific examples of such techniques.

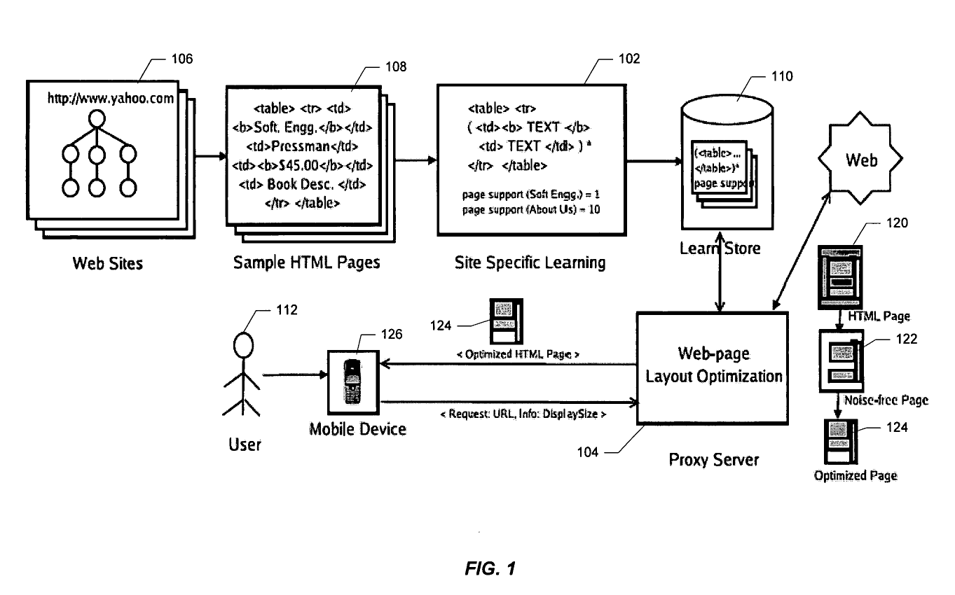

An example of a specific implementation of a system incorporating an embodiment of the invention will now be described with reference to FIG. 1. The system includes two major components: site specific noise identification (102) and web page layout optimization (104). Techniques relating to particular implementations of component 102 are described in U.S. patent application Ser. No. 12/055,222 (EFS ID 3051236 and Confirmation No. 7427; Y! reference. Y02833US00), the entire disclosure of which is incorporated herein by reference for all purposes.

Given a particular website (106), the first component takes some sample of web pages (108) and constructs a template with reference to the structure of those samples. It then identifies site-specific noise using the structural and content features repeating across the sample pages. For each website the template and associated learned information are stored (110).

It should be noted that this first system component may be fully automated, or involve some level of human interaction. That is, a human evaluator may be involved in the process and may, for example, identify sections of one or more sample web pages for a given site as having low relevance or comprising “noise.” Subsequent evaluation of other pages from that site may then employ this input. Given that human evaluation typically is highly accurate, such an approach may be particularly effective for some applications. For example, in a particular application, a web site owner might want to optimize web pages for mobile devices with human input instead of just eliminating noisy portions of the web page, e.g., a human/web master could assign a relevance score near to zero for a particular web page portion if he does not want it to be part of final layout on mobile pages. As mentioned, optimizations resulting from such human input for a sample set of pages are subsequently applied to structurally similar pages from the same site.

After the site-specific learning described above, whenever a user (112) requests a web page from that site, a proxy server (e.g., 104) fetches the page and matches it with the stored template for that site. The web page is then divided into sections using the template and possibly other features associated with the page, e.g., tag properties, and an importance or relevance value is assigned to each section.

The web page layout module (104) takes the sectioned web page (120), scales the sections based on their importance score, removes irrelevant sections or noise (122), and then identifies the optimal layout (124) based on the display size of the device (126) and spatial relationships among the different sections. The optimized page (124) is then transmitted to the device (126) for presentation.

It should be noted that the size of the target display which is used to configure web pages may not correspond to the actual physical dimensions of the screen of the device. According to some embodiments, the scrolling capabilities of the device are taken into account when specifying the size of the target display. That is, if a device enables scrolling, the size of the target display used for configuring web pages may take this into account. So, for example, if a device enables vertical but not horizontal scrolling, the vertical dimension of the target display size need not be limited to the vertical dimension of the device's actual screen. Similarly, if both vertical and horizontal scrolling are enabled, neither the vertical nor horizontal dimension of the target display size need be limited by the actual physical dimensions of the screen.

A specific technique for partitioning or sectioning a web page into different sections and identifying section importance which may be used to implement the first system component described above with reference to FIG. 1 will now be described. However, as mentioned herein, it should be noted that the described technique is merely an example of a variety of techniques which can be used to perform these functions.

This particular technique works at the site level and relies on the observation that, for a given web site, the informative or more relevant parts of web pages are relatively diverse in terms of content and/or presentation (structure), whereas the noisy or less relevant parts often share common content, link, and presentation styles. In this example, text, links, and images embedded in tags in a web page are considered as “content.” The approach makes use the notion of a “template” to capture structural and content repetition. As used herein, a template is a regular expression learned over a set of structures of pages within a site. An initial template is constructed based on the structure of one page and is then generalized over a set of additional pages by adding a set of operators if the new pages are not matched. This particular approach uses three operators: “*,” “?,” and “|.” The operator “*” denotes multiplicity (i.e., repetition of similar structure) in the structural data. The operator “?” denotes optionality (i.e., part of the structure being optional) in the structural data. The operator “|” denotes disjunction (i.e., the presence of one of several structures) in the structural data. Thus, the template becomes a generalized structure of pages seen until the current time.

To illustrate this, consider the following template: (A)*B(C)?D(E|F), where A, B, C, D, E, and F represent a set of nodes in the structure. For example, A might represent a set of HTML nodes like <TABLE><TR><TD><IMG></TD></TR></TABLE>. This template matches all pages having their HTML structure as ABCDE, AABCDE, ABDE, ABDF, ABCDF, etc.

Templates help to capture structural and content repetition across pages which may then be used to determine section importance. Also, templates capture sets of structurally similar items under a STAR (*) node to facilitate the segmentation process.

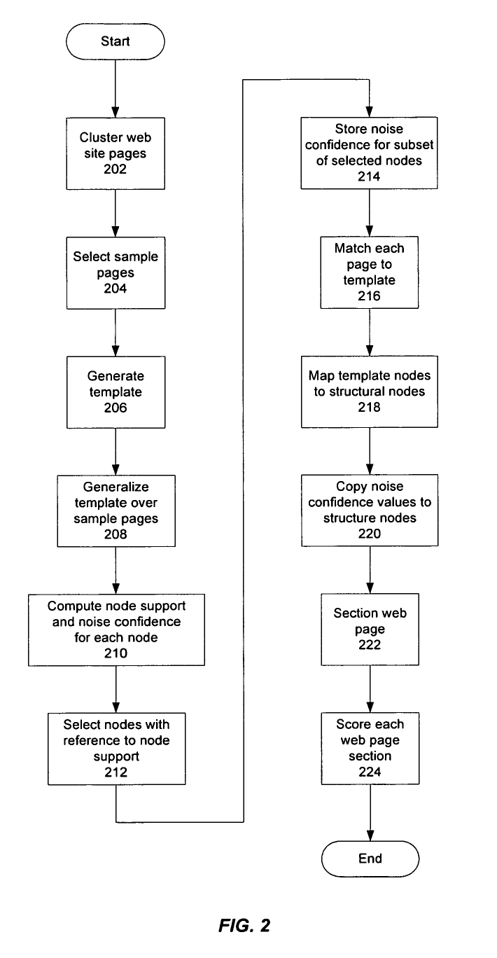

A particular implementation of a template-based approach (described below with reference to the flowchart of FIG. 2) may be divided into two phases; a Site Specific Learning Phase in which structural and content repetition is learned across pages; and a Segmentation and Section Importance Detection Phase in which a web page is segmented and noisy sections are detected using a template, content, and visual Information.

During the Site Specific Learning phase all pages belonging to a site are either assumed as a cluster, or clustered based on their URL presentations, structural homogeneity, or both (202). This may be done using any suitable clustering method.

For each cluster, k random sample web pages are selected (204), and a template is then created (206) and generalized (208) over the k samples. During template generalization, values for each feature (if present) are computed or updated for each leaf template node based on corresponding structure nodes. In this example, leaf template nodes are image (IMG) and text (TEXT) nodes, and the set of features used include page support for each template node, page support for each image source feature, page support for each link feature, and page support for each text feature mapping to a template node. The feature set can be extended to consider other features like HTML node properties, image height, image width, font size, etc. Page support for a feature/node is defined as the number of pages including that particular feature/node.

After generalizing the template over the k samples, the node support and feature noise confidence is computed at each leaf template node (210). The computation is done based on the node's previously computed features statistics. For example, consider a sample size k=20. If a template node has a page support=18 and includes text features, “About us” with page support=17, and “click here” with page support=1, then the template node has a node support of 18/20=90%, a noise confidence for text feature “About us” of 17/18=94.44%, and a noise confidence for text feature “click here” of 1/18=5.56%. This helps to detect noise which is local to a cluster of pages.

Template nodes having node support greater than a particular threshold (e.g., 20%) are considered (212). For these nodes, noise confidence values for content (image source, link, and text) features are stored if above a certain threshold (e.g., 20%) (214). As will be understood, these thresholds can be varied to manipulate noise identification quality for particular applications. Note that, as mentioned earlier, instead of automatic learning of the section importance, this input can be taken from human.

During a noise detection phase, each page in a cluster is matched with the template constructed for that cluster as a part of learning template phase (216). The mapping of each template node to a corresponding set of structural nodes in a page is also obtained (218). Noise confidence scores are copied to leaf structure nodes based on the presence of a content feature (220). So, in the example described above, if a structure node mapping to a particular template node has the content “About us,” the noise confidence value of that content feature (e.g., 94.44%) is copied from the template node to the structure node.

The web page is partitioned into set of sections (222), and the noisiness score is computed for each section (224).

According to a specific embodiment, web page partitioning is accomplished as follows. Web pages often contain lists of items, e.g., lists of products or lists of navigational links, where each item is represented by a set of HTML nodes. Each such list may be treated as a section as all items in a given list are likely either all informative or all noisy. The STAR (“*”) template node in a template may represent such a list. In such a case, all HTML nodes mapping to a STAR template node are treated as a part of a section. A structure node is said to be mapped to a STAR template node if it has a mapping to a template node contained in the STAR template node. Note that a STAR node may contain another STAR node. In such a case, a STAR node which is not contained in any other STAR node is considered to be a section.

It should be noted that in this approach, it is assumed that the DOM tree for the page is available and therefore for the remaining page, the following steps may be used to obtain the set of sections. However, the method described below is HTML tag specific and should be treated as optional for other standard scripting formats.

We assumed a predefined classification of the finite HTML tag set into the following categories:

i. Sectioning tags—generally, HTML nodes such as TABLE and DIV are used to define a section.

ii. Section separating tags—generally, HTML nodes such as HR and FRAMESET are used to separate a section.

iii. Rich text formatting tags—generally, HTML nodes such as B, I, and STRONG are used to enhance the richness of text and do not introduce any line breaks. If a DOM node and its entire sub-tree belong to the this category, that DOM node is designated as a “Rich Text Formatting Node.”

iv. Dummy tags—HTML tags such as COMMENT and SCRIPT are considered as dummy tags which can be ignored for segmentation purpose.

v. Other tags—any tags other than those falling into the above categories are considered as “other tags.”

We also assumed that visual information is available on each structural node. This can be obtained by rendering the web page through a browser, or obtained approximately.

The segmentation process is top-down over the DOM tree. Each DOM node is checked to determine whether it is already part of a section. This could happen, for example, if a node is part of STAR template node. If a DOM node is already part of a section, it is not processed further. Otherwise, node is checked against the following set of conditions:

i. Condition 1—the ratio of the node's area to the web page area is greater than some threshold (e.g., 15%). The area of a node is computed as the node height multiplied by the node width. Node height and width are available as part of the visual information associated with that DOM node.

ii. Condition 2—One of the node's children belongs to the “Sectioning tag” category and satisfies Condition 1.

iii. Condition 3—One of the node's children belongs to the “Section Separating tag” category.

If a node satisfies Condition 1 and Condition 2, its children are processed similarly with reference to the same conditions. If the node satisfies Condition 3, all children belonging to the “Section Separating tag” category are treated as section separators. Child DOM nodes between two section separators, or between the first node and the first section separator, or between the last section separator and the last node are treated as separate sections. For example, consider a DOM node Z has satisfied Condition 3, and has a children sequence ABCPQCSTCXY, in which “C” belongs to the “Section Separating tag” category. Then the resulting section set includes four sections, i.e., sections 1 through 4 containing DOM nodes AB, PQ, ST, and XY, respectively.

If none of the conditions are satisfied, the DOM node is marked as a section.

Note that, all contiguous, sibling rich text formatting nodes are considered as sections. For example, if a DOM node sequence is BITXSTI, where DOM nodes BITS are rich text formatting nodes and X is not, then the resulting section includes three sections, i.e., sections 1 through 3 containing nodes BIT, X, and STI, respectively. BIT and STI are examples of contiguous, rich text formatting subtrees.

Once the segmentation process is complete, each section is assigned an importance score. According to a specific implementation, the noise confidence of each leaf structure node is aggregated at the section level to determine the noise confidence of the section. The aggregation is a weighted averaging of all noise confidence values of leaf structure nodes based on size. The section importance score is computed as (1—section noise confidence). The importance score ranges between 0 and 1.

A specific implementation of the approach to section importance detection described above was evaluated against 18 domains by randomly selecting 15 pages for learning and 65 pages for testing. Based on section importance, each section was classified into one of two categories, informative or noisy. If a section importance was less than some threshold (e.g., 25%), it was classified as noisy. Otherwise the section was classified as informative. The evaluation of section classifications was done manually. Three evaluators were presented with a set of sections and their assigned classifications, and were asked to verify the quality and correctness of the classifications. According to the evaluation, the approach to section importance detection was able to detect noisy sections with an average of 91% precision and 82% recall. In addition, it was learned that this approach to section importance detection was able to effectively form sections out of similar items (even items with slight structural and/or visual differences). This is believed to be a result of the template learning over a set of pages.

Once a web page is sectioned and the sections scored, the problem becomes one of optimizing the layout of a plurality of rectangles corresponding to some or all of the web page sections. As mentioned above, the foregoing technique for sectioning and scoring web pages is merely one example of the variety of techniques by which such a set of rectangles may be generated. Therefore, the scope of the invention should not be limited by such references.

The input to the layout optimization algorithm is a set of rectangular blocks. The rectangles are specified by four parameters: (x, y, w, h)—the location, (x, y), of the top-left corner, the width, w, and the height, h. Note that in this example the sizes of the blocks are determined by section importance models and not by the layout algorithm itself. The layout algorithm may also perform “area-preserving resizing” for some blocks. Layout optimization algorithms minimize the amount of space used to layout a given set of blocks. However, embodiments of the invention are contemplated in which block sizing is integrated with this aspect of the invention.

Before discussing layout optimization algorithms enabled by the present invention, it may be instructive to discuss properties of sectioning techniques and sections which may have an effect on layout optimization. Generally speaking, sectioning algorithms can be characterized as fine or coarse. For example, sectioning algorithms based on feature homogeneity usually over-segment a page resulting in relatively fine-grained sections. On the other hand, coarse sectioning algorithms provide logical sections which may be the result of combining seemingly heterogeneous sections. Consider the example of a news page contains multiple stories with associated images. Fine-grained sectioning algorithms typically create separate text and image sections. Coarse sectioning algorithms, on the other hand, typically create composite sections combining text sections with the associated image sections so that the logical sections correspond to complete news stories.

In the case of fine-grained sections, a layout process which preserves spatial relations between sections is typically desirable. In the news page example, if the spatial relations are not preserved, the stories and images will get jumbled up. On the other hand, if the underlying algorithm creates logical sections, reordering will likely be acceptable in most cases. Again using the news example, reordering of news stories is usually acceptable. It should be noted that, in general, a layout optimization which preserves spatial relations is likely to be less efficient in the use of space than other approaches.

An additional observation which may be instructive relates to the nature of sections. The input rectangles (or sections) to a layout optimization algorithm may be characterized as belonging to two classes, i.e., rigid sections and flexible sections. For rigid sections (e.g., images), the aspect ratio should not be changed. On the other hand, flexible sections (e.g., those containing only text) can be resized provided the overall area of each section is maintained. It should be noted that a third intermediate class of sections is contemplated in which some measure of flexibility is allowed subject to some constraints beyond the constraints imposed on the resizing of flexible sections. An example of such a section might be a table in which the aspect ratios of cells may be changed as long as the information included in most or all of the cells remains readable.

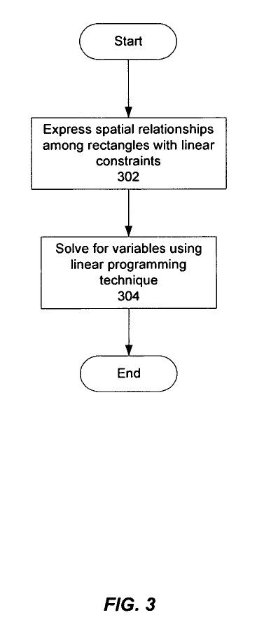

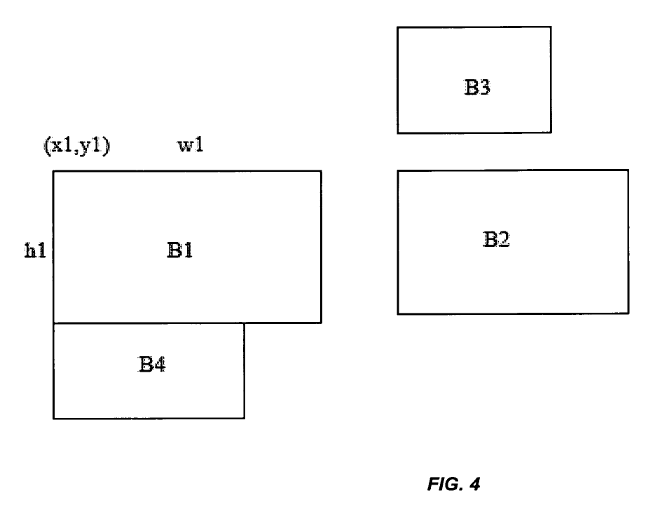

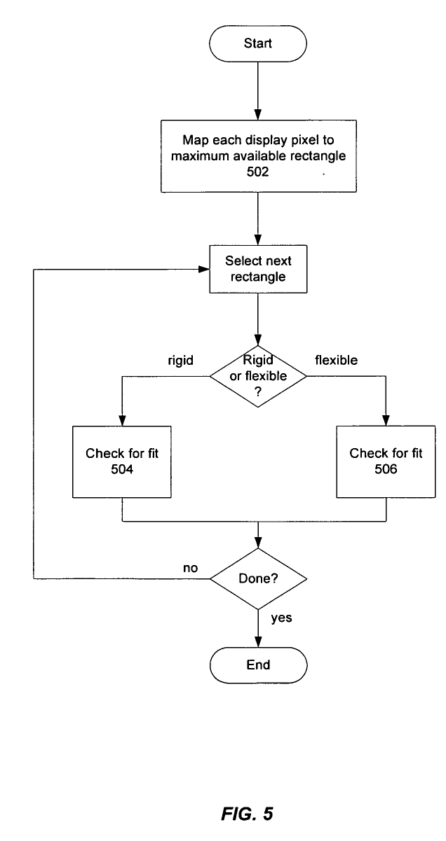

Two examples of layout optimization algorithms enabled by the present invention will now be described. The first algorithm (described below with reference to FIGS. 3 and 4) minimizes the space used while preserving the spatial constraints of the input blocks, i.e., the spatial relationships among the rectangles. The second algorithm (described below with reference to FIG. 5), which allows the reordering of blocks, attempts to minimize the total amount of space used for the layout, and supports both rigid and flexible sections.

According to a first approach to layout optimization, the spatial relations between rectangles (also referred to herein as sections or blocks) are expressed using linear equations and/or inequalities (302). This may be understood with reference to the example set of blocks shown in FIG. 4. Let (xᵢ, yᵢ) be the coordinate of the top-left corner of rectangle i. Thus, the constraint that block B1 is to the left of block B2 may be expressed:

x₁+w₁≦x₂

The constraint that block B3 is above block B2 may be expressed:

y₂≦y₃−h₃

The constraint that block B1 is flush with block B4 may be expressed:

y₁−h₁=y₄

Given a set of rectangles described in such a format, it should be noted that it is possible to automatically capture these constraints.

Once the constraints are expressed as linear equations and/or inequalities, any of a variety of linear programming techniques may be employed to solve for the variables (304). According to a particular implementation, the Cassowary solver is used. For more information regarding the Cassowary solver, please refer to G. J. Badros, A. Borning, and P. J. Stuckey. The Cassowary linear arithmetic constraint solving algorithm. ACM Transactions on Computer-Human Interaction (TOCHI), 2001, the entire disclosure of which is incorporated herein by reference for all purposes. As mentioned above, the present invention is not limited to any particular linear programming technique.

According to a second approach to layout optimization, the total amount of space required for the layout is minimized. According to some embodiments, because the number of rectangles to be laid out is typically small (≅5), a simple exhaustive search algorithm is employed.

Depending on the target device, horizontal scrolling may be considered more taxing for users compared to vertical scrolling. Therefore, according to one class of embodiments, the packing of rectangles is performed in “row major” order. That is, each row is checked to determine if it has enough space to accommodate a section under consideration. If it does not have enough room, the next row is checked. In this way, if none of the currently available rows has enough space for the section under consideration, a new row will be introduced and the section will be assigned to it. This helps to avoid horizontal scrolling in that, if the section under consideration exceeds available space constraints, it will not be considered for that row. Some embodiments also support area-preserving resizing of flexible sections.

According to a specific embodiment illustrated in FIG. 5, the layout optimization algorithm maintains a data structure which indicates for each pixel (i, j) in a display area of size (wᵢⱼ, hᵢⱼ) the maximum available rectangle starting at (i, j) (502). Let the input rectangle size be (w, h). For rigid rectangles (e.g., images), the check for fit (504) is given by:

wᵢⱼ≧w and hᵢⱼ≧h

In case of flexible rectangles (e.g., text), the check for fit (506) is given by:

wᵢⱼ×hᵢⱼ≧h×w and wᵢⱼ≧α×w and hᵢⱼ≧α×h

where α determines how elastic the resizing is. α=1 corresponds to a rigid rectangle. Thus, appropriate values of a may be employed to achieve different levels of flexibility suitable for particular rectangle or section types and/or particular applications.

According to some embodiments, if the content associated with a section may be summarized in some way, this may be done to further promote resizing of that section. That is, for example, if the text in a cell in a table may be truncated or abbreviated without unduly detracting from the information conveyed by the table, such a truncation or abbreviation could facilitate a more significant resizing of the table than might otherwise be possible.

As discussed above, embodiments of the invention allow web page layouts to be optimized based on section importance. According to specific embodiments, section importance is used to scale and/or reorder the sections of a web page. According to some embodiments, section resizing is done with the constraint that that text have a minimum font size to ensure that resized sections are still visible to users. Some examples of layout results enabled by embodiments of the invention may be instructive.

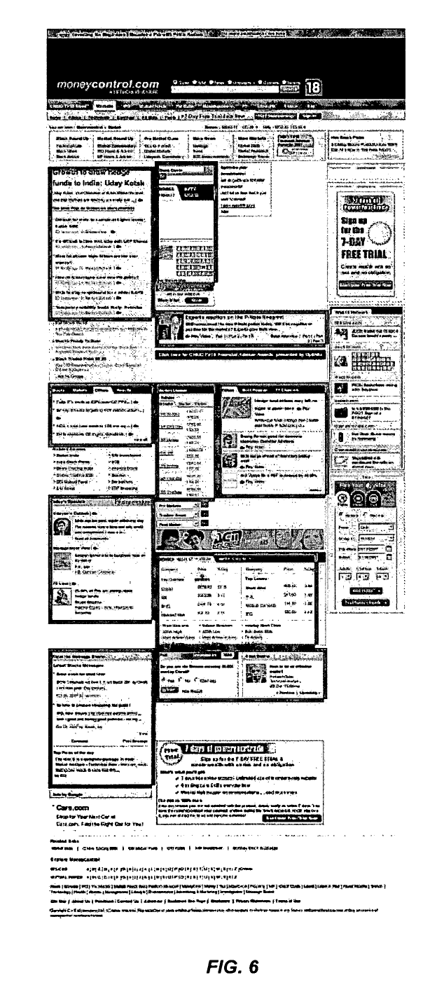

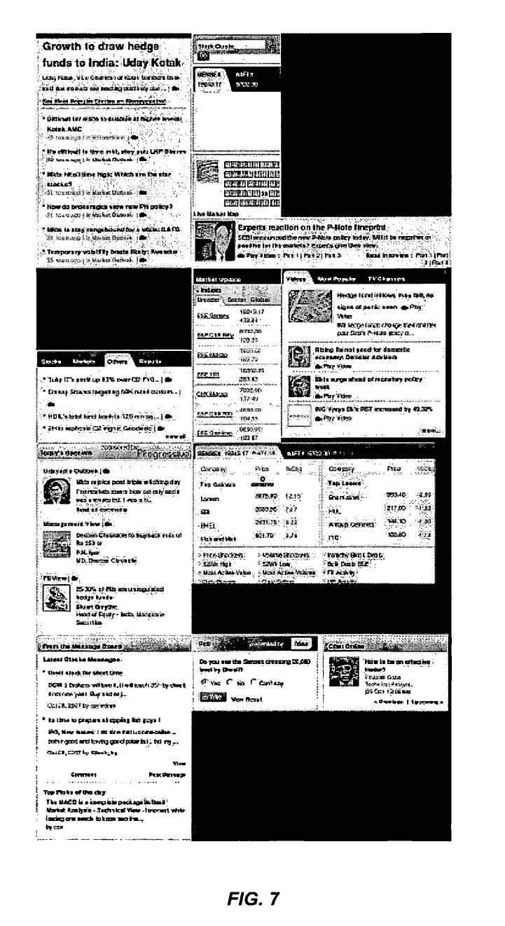

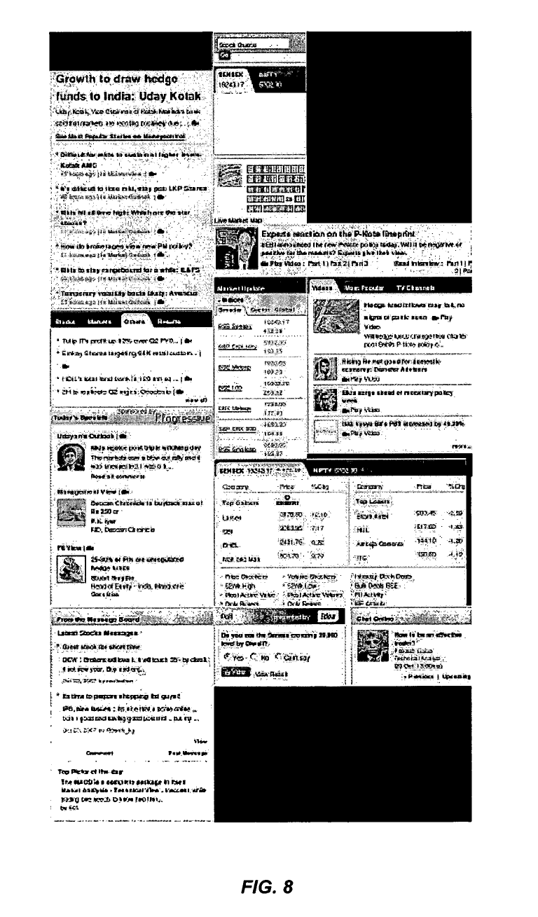

FIG. 6 shows an example of a web page which may be laid out according to the invention. The informative sections (i.e., the rectangles to be configured) are marked with thick borders. FIG. 7 illustrates a spatial relation preserving layout produced from the web page of FIG. 6 using a linear programming technique as described above with reference to FIG. 3. While all spatial relations are preserved, there are several blank areas. According to some embodiments, it is permissible to relax some spatial relation constraints. An example of the effect of this is shown in the layout of FIG. 8 which has fewer blank areas.

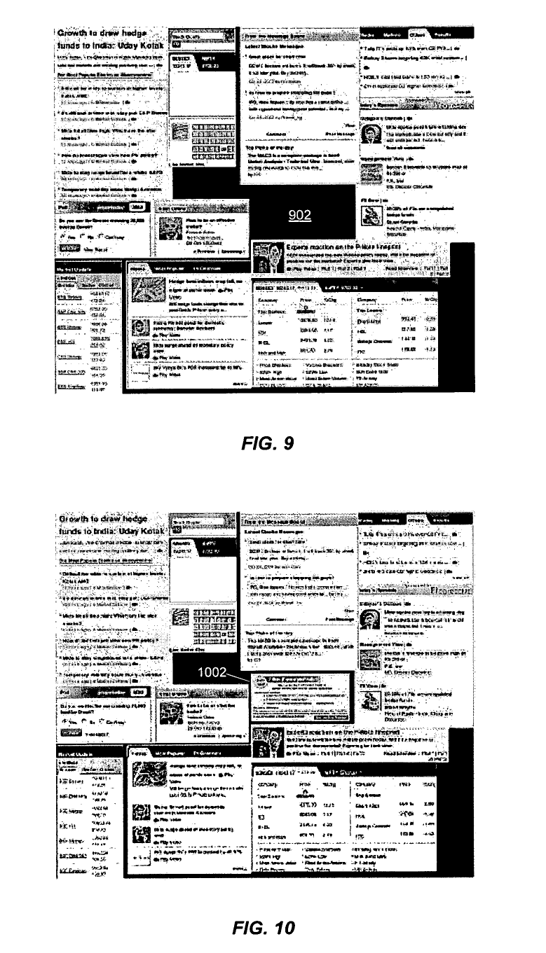

By contrast, FIG. 9 shows a layout produced from the web page of FIG. 6 using an exhaustive search approach as described above with reference to FIG. 5. As shown, this results in a layout which is more compact. However, spatial relations are not preserved.

It can be seen from the examples of FIGS. 6-9 that, while various approaches enabled by the invention represent significant improvements in the use of space, there are many cases for which removal of all blank spaces in a layout may be difficult or impossible. Therefore, according to specific embodiments of the invention, additional content is inserted in one or more of any remaining blank spaces. An example of this is shown in FIG. 10 in which an advertisement 1002 is inserted in one of the blank spaces of the layout shown in FIG. 9 (i.e., blank space 902). It should be noted that the inserted content may or may not have been included in the original web page. That is, for example, when such a blank space is identified, content which may have originally been culled from the web page, e.g., an advertisement, during an earlier stage of the process may be reinserted. Alternatively, new content not present in the original page may be inserted.

In addition to laying out web pages in a manner which is suitable for the particular device type and display size, embodiments of the invention may be characterized by additional advantages. For example, one obstacle to the success of mobile Internet services is information access latency. Low bandwidth wireless networks cause delay in accessing particular types of information resulting in negative user experience. For example, users connecting through low bandwidth devices find that noisy information (e.g., advertising images) substantially impede their browsing. By identifying such noise information and summarizing, resizing, or eliminating, embodiments of the invention address such issues.

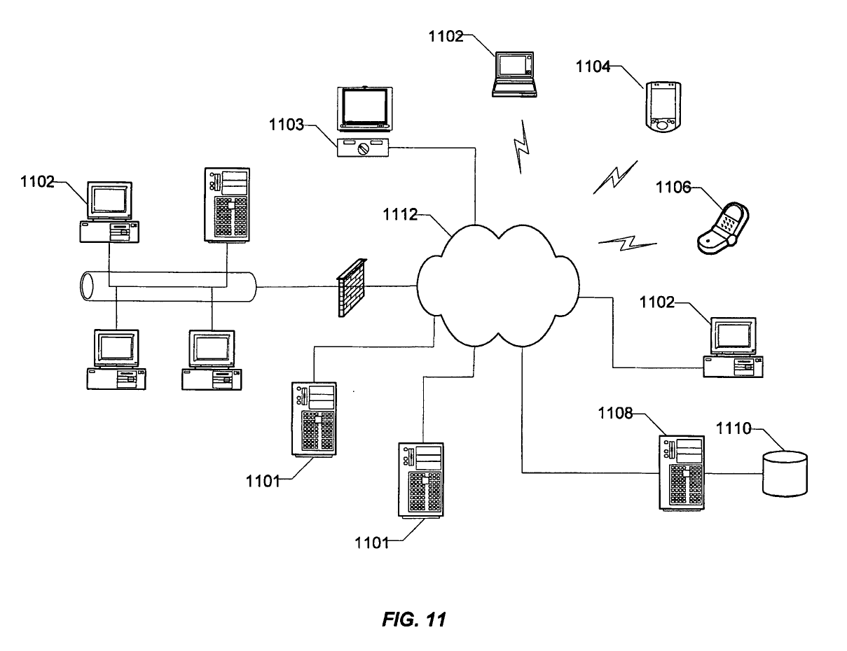

Embodiments of the present invention may be employed to optimize the layout of web pages and to present web pages optimized according to the invention in any of a wide variety of computing contexts. For example, as illustrated in FIG. 11, implementations are contemplated in which a population of users interacts with web sites 1101 via a diverse network environment using any type of computer (e.g., desktop, laptop, tablet, etc.) 1102, media computing platforms 1103 (e.g., cable and satellite set top boxes and digital video recorders), handheld computing devices (e.g., PDAs) 1104, cell phones 1106, or any other type of computing or communication platform. As will be understood, web pages created for presentation on any particular device or display type may be optimized in accordance with the invention for presentation on any other device or display type.

Web pages laid out according to the invention may be processed in some centralized manner. This is represented in FIG. 11 by server 1108 and data store 1110 which, as will be understood, may correspond to multiple distributed devices and data stores. Alternatively, web pages may be laid out according to the invention in a much more distributed manner, e.g., at individual web sites, or for specific groups of web sites. The invention may also be practiced in a wide variety of network environments including, for example, TCP/IP-based networks, telecommunications networks, wireless networks, etc. These networks are represented by network 1112. Web pages laid out in accordance with the invention may then be provided to users via the various channels with which the users interact with the network.

In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. For example, techniques described herein for optimizing web page layout may be employed in the context of search and, more specifically, for the dynamic creation of search results pages. That is, when a user enters a search query, a number of components of a responsive search results page are generated, at least some of which may have associated scores or values which may be employed to denote the relevance or importance of the components with which they are associated. The search results page may therefore be optimized with reference to such scores or values and for the particular display size on which the page is to be displayed.

In addition, and as mentioned above, the input to web page layout techniques enabled by the present invention (i.e., a plurality of rectangles sized in accordance with corresponding relevance or importance values) may be generated using a wide variety of techniques. Such techniques can range from the sophisticated, machine-learning approach described herein to manual sectioning and scoring by human operators. Moreover, it should be noted that the rectangles themselves can come from a variety of sources and/or be generated by or provided by multiple applications or sources within a single layout, and therefore need not be generated together or by the same entity.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for configuring a web page characterized by an original layout for presentation on a display having a display area, the method comprising:
receiving web page section data as input, the web page section data representing rectangular sections of the web page, each rectangular section having been derived from the original layout and scaled with reference to a relevance measure for the corresponding rectangular section; and
manipulating the web page section data with reference to the display area to arrange the rectangular sections in a new layout smaller than the original layout.

2. The method of claim 1 wherein the web page section data include spatial relationship data which represent spatial relationships among the rectangular sections of the web page in the original layout, and wherein manipulation of the web page section data is done in a manner which preserves at least some of the spatial relationships.

3. The method of claim 1 wherein manipulation of the web page section data is done in a manner which attempts to minimize a layout area corresponding to the new layout without regard to spatial relationships among the rectangular sections in the original layout.

4. The method of claim 3 wherein manipulation of the web page section data involves application of a linear programming technique to linear constraints representing the rectangular sections.

5. The method of claim 1 wherein the web page section data represent a first aspect ratio and a first rectangular area each corresponding to a first one of the rectangular sections, and wherein manipulation of the web page section data is done in a manner which changes the first aspect ratio of the first rectangular section while preserving the first rectangular area.

6. The method of claim 1 wherein the web page section data represent a first aspect ratio corresponding to a first one of the rectangular sections, and wherein manipulation of the web page section data is done in a manner which requires preservation of the first aspect ratio of the first rectangular section.

7. The method of claim 1 further comprising generating the web page section data by:
dividing a representation of the web page into a plurality of original sections of the web page;
generating the relevance measure for each of the original sections of the web page; and
eliminating one or more of the original sections of the web page with reference to the corresponding relevance measures, remaining ones of the original sections of the web page corresponding to the rectangular sections of the web page.

8. The method of claim 7 further comprising resizing at least some of the remaining original sections of the web page with reference to the corresponding relevance measures to derive the rectangular sections of the web page.

9. The method of claim 1 wherein the new layout includes blank space not covered by any of the rectangular sections, the method further comprising inserting additional content into the blank space.

10. The method of claim 1 wherein the plurality of rectangles were originally generated by a plurality of applications.

11. A computer program product for configuring a web page characterized by an original layout for presentation on a display having a display area, the computer program product comprising at least one computer-readable medium having computer program instructions stored therein configured to cause at least one computing device executing the computer program instructions to:
receive web page section data as input, the web page section data representing rectangular sections of the web page, each rectangular section having been derived from the original layout and scaled with reference to a relevance measure for the corresponding rectangular section; and
manipulate the web page section data with reference to the display area to arrange the rectangular sections in a new layout smaller than the original layout.

12. The computer program product of claim 11 wherein the web page section data include spatial relationship data which represent spatial relationships among the rectangular sections of the web page in the original layout, and wherein the computer program instructions are configured to cause the at least one computing device to manipulate the web page section data in a manner which preserves at least some of the spatial relationships.

13. The computer program product of claim 11 wherein the computer program instructions are configured to cause the at least one computing device to manipulate the web page section data in a manner which attempts to minimize a layout area corresponding to the new layout without regard to spatial relationships among the rectangular sections in the original layout.

14. The computer program product of claim 13 wherein the computer program instructions are configured to cause the at least one computing device to manipulate the web page section data through application of a linear programming technique to linear constraints representing the rectangular sections.

15. The computer program product of claim 11 wherein the web page section data represent a first aspect ratio and a first rectangular area each corresponding to a first one of the rectangular sections, and wherein the computer program instructions are configured to cause the at least one computing device to manipulate the web page section data in a manner which changes the first aspect ratio of the first rectangular section while preserving the first rectangular area.

16. The computer program product of claim 11 wherein the web page section data represent a first aspect ratio corresponding to a first one of the rectangular sections, and wherein the computer program instructions are configured to cause the at least one computing device to manipulate the web page section data in a manner which requires preservation of the first aspect ratio of the first rectangular section.

17. The computer program product of claim 11 wherein the computer program instructions are further configured to cause the at least one computing device to generate the web page section data by:
dividing a representation of the web page into a plurality of original sections of the web page;
generating the relevance measure for each of the original sections of the web page; and
eliminating one or more of the original sections of the web page with reference to the corresponding relevance measures, remaining ones of the original sections of the web page corresponding to the rectangular sections of the web page.

18. The computer program product of claim 17 wherein the computer program instructions are further configured to cause the at least one computing device to resize at least some of the remaining original sections of the web page with reference to the corresponding relevance measures to derive the rectangular sections of the web page.

19. The computer program product of claim 11 wherein the new layout includes blank space not covered by any of the rectangular sections, and wherein the computer program instructions are further configured to cause the at least one computing device to insert additional content into the blank space.

20. The computer program product of claim 11 wherein the plurality of rectangles were originally generated by a plurality of applications.

21. A computer-implemented method for facilitating presentation of a web page characterized by an original layout on a display having a display area, comprising causing a representation of the web page to be transmitted to a device including the display, the representation of the web page being characterized by a new layout smaller than the original layout, the new layout representing an arrangement of rectangular sections of the web page, each rectangular section having been derived from the original layout and scaled with reference to a relevance measure for the corresponding rectangular section, the arrangement of the rectangular sections having been derived with reference to the display area.

22. The method of claim 21 wherein the original layout of the web page is characterized by spatial relationships among the rectangular sections, and wherein the new layout preserves at least some of the spatial relationships.

23. The method of claim 21 wherein the original layout of the web page is characterized by spatial relationships among the rectangular sections, and wherein the new layout minimizes a layout area without regard to the spatial relationships.

24. The method of claim 21 wherein a first one of the rectangular sections of the web page is characterized by a first aspect ratio and a first rectangular area in the original layout, and wherein the first rectangular section has a different aspect ratio in the new layout while preserving the first rectangular area.

25. The method of claim 21 wherein the new layout includes additional content inserted in a space not covered by any of the rectangular sections.
